(19) United States
(12) Patent Application Publication
(10) Pub. No.: US 2008/0274372 A1
(43) Pub. Date: Nov. 6, 2008

(54) Corrosion Resistant Object Having an Outer Layer of a Precious Metal

(75) Inventors: Bo Gillesberg, Augustenborg (DK); Erik Christensen, Lyngby (DK); Hans Joergen Pedersen, Ilsfeld (DE)

Correspondence Address: MCCORMICK, PAULDING & HUBER LLP, CITY PLACE II, 185 ASYLUM STREET, HARTFORD, CT, 06103, US

(73) Assignee: DANFOSS A/S, Nordborg (DK)

(21) Appl. No.: 11/917,206

(22) PCT Filed: Jun. 14, 2006
(86) PCT No.: PCT/DK2006/000341

§ 371 Date: Jul. 3, 2008

(30) Foreign Application Priority Data
Jun. 15, 2005 (DK) PA 2005 00877

(51) Int. Cl. B32B 15/01; B05D 5/12

(52) U.S. Cl. 428/662; 205/238; 427/77; 427/78

(57) ABSTRACT

An object comprising a conductive body part, a layer comprising a refractory metal (e.g. tantalum), and a layer comprising a precious metal (e.g. platinum or gold). A metallurgical bond has been formed between the layers. Thereby oxidation of the refractory metal layer, and thereby passivation of the object, can be avoided even with small amounts of precious metal. This lowers the material costs while ensuring desired corrosion resistant properties. The object is suitable for an electrode to be used in a corrosive environment, in particular when a large conductivity is needed. Also a method of manufacturing the object. The metallurgical bond is provided by heating the object.

### FIELD OF THE INVENTION

The present invention relates to an object which on the one hand is resistant towards corrosion, and on the other hand is electrically conductive. Furthermore, the present invention relates to a method for manufacturing such an object in manner which is cost effective without compromising the corrosion resistant or conductive properties of the object. An object according to the present invention may advantageously be applied as an electrode which is to be used in a corrosive environment.

### BACKGROUND OF THE INVENTION

For some purposes it is desirable to provide corrosion resistant surfaces which are electrically conductive. This is, e.g., relevant when manufacturing electrodes which are to be used in a hostile or aggressive medium, such as an acid, a base, ion containing environments, such as chloride, etc. At the present time such electrodes are typically either made from a precious metal, such as gold or platinum, or from a corrosion resistant material, such as tantalum, niobium, titanium, zirconium, etc., with an outer layer of a precious metal having a thickness of approximately 1 μm to 20 μm. The outer layer may be applied using an electrochemical reaction, e.g. a Degussa process, or it may be laminated onto the surface as a foil. These methods provide an electrically conductive surface, and a corrosion resistance which is determined by the material of the lower layer is obtained. The thickness of the layer of precious metal must be sufficient to ensure that the layer is at least substantially tight, i.e. that it is substantially pinhole free. If pinholes occur in the layer, there is a risk that the refractory metal will oxidise during conduction, and that an oxide film is thereby formed beneath the precious metal layer. This is highly undesirable because it may lead to passivation of the surface of the object. Electrodes of the kind described above, are, e.g., disclosed in EP 0 679 733.

Another approach is disclosed in GB 1 355 797, describing electrodes based on substrates, which are not corrosion resistant, the substrates being covered by a corrosion protective layer of a passive metal having a thickness of 0.5 mm to 1.0 mm. On top of that a conductive layer of precious metal is positioned in order to prevent the passive layer from oxidising. In this situation pinholes may be accepted in the precious metal layer since corrosion will not evolve under the precious metal layer. The precious layer, however, still needs to be sufficiently tight (cohesive) to avoid the passive metal from passivating under the precious metal.

In the case where the precious metal layer is very thin, it may become too porous to suppress oxide formation on the passive metal. This situation may also occur if the precious metal layer is relatively thick, but has a powdery appearance, i.e. if the precious metal layer is not substantially cohesive. For normal application technology, such as PVD or electrodeposition, these effects are seen at layer thicknesses in the range 1 μm or less. The production costs are thereby limited by the price of the precious metal, and the amount of necessary precious metal becomes an economical barrier for producing electrodes at low cost.

There are situations where the methods described above are not applicable. This is, e.g., the case if a relatively high conductivity is desired. Furthermore, since precious metals are normally relatively expensive, the costs involved in manufacturing the electrode entirely from a precious metal or providing a layer of precious metal of a sufficient thickness are sometimes considered too high.

### SUMMARY OF THE INVENTION

Thus, it is an object of the present invention to provide a corrosion resistant and electrically conductive object which is cost effective to manufacture.

It is a further object of the present invention to provide a corrosion resistant object having a relatively high electrical conductivity.

It is an even further object of the present invention to provide an electrode which may be used in corrosive environments, and which is cost effective to manufacture.

It is an even further object of the present invention to provide a method of manufacturing a corrosion resistant and electrically conductive object in a cost effective manner.

According to a first aspect of the invention, the above and other objects are fulfilled by providing an object comprising:
an electrically conductive body part,
a first layer comprising a refractory metal or an alloy of a refractory metal, said first layer at least substantially covering an outer surface of the body part, and
a second layer comprising a precious metal, said second layer at least substantially covering the first layer,
   wherein a metallurgical bond has been formed between the first and the second layer.

In the present context the term ‘metallurgical bond’ should be interpreted to mean a direct metal-to-metal interface.

The body part is electrically conductive, i.e. it is capable of conducting an electrical current. Thereby the object will be electrically conductive, and the conductivity of the object will be determined by the material selected for the body part.

The object further comprises a first layer comprising a refractory metal or an alloy of a refractory metal. Such materials are known to be corrosion resistant, and the first layer therefore provides the desired corrosion resistant properties to the object.

Thus, a desired conductivity may be obtained by selecting an appropriate material for the body part, without taking the corrosion resistant properties of this material into account, because the object will be protected (in terms of corrosion) by the first layer. Similarly, the material of the body part may be selected in accordance with other desired properties, such as heat conductivity, tensile strength, hardness, etc.

Finally, the second layer comprising a precious metal ensures that the surface of the object is also conductive. Furthermore, the second layer prevents oxidation of the refractory metal layer during conduction. The precious metal may, e.g., be gold, platinum, or any other suitable precious metal.

Due to the fact that a metallurgical bond has been formed between the first and the second layer, passivation beneath the precious metal layer can be avoided, even with a relatively thin layer of precious metal where it can not be guaranteed that the layer is pinhole free. Thereby an electrically conductive and corrosion resistant object has been provided in which the material costs have been reduced relatively to prior art objects of this kind, because the amount of precious metal needed in order to prevent passivation of the object is considerably less than the amount needed in prior art objects. This is a great advantage.

The body part is preferably made from or comprises a metal or an alloy, such as copper, silver, titanium, or any other suitable kind of metal, or an alloy thereof.

The first layer may have a thickness within the interval 2 μm to 200 μm, such as within the interval 5 μm to 125 μm, such as within the interval 10 μm to 50 μm. In the present context the thickness of the layer should be interpreted as the thickness of a part of the object comprising the refractory metal or the alloy of a refractory metal in a concentration which is above a specific level. In any event the thickness of the first layer should be sufficient to protect the body part from corrosion. The thickness of the layer may accordingly depend on the intended environment of use, the refractory metal present in the layer, and the exact material composition of the layer.

The second layer may have a thickness within the interval 0.01 μm to 25 μm, such as within the interval 0.01 μm to 5 μm, such as within the interval 0.1 μm to 2 μm. Preferably, the thickness of the second layer should be chosen in such a way that it is sufficient to prevent passivation of the object, but not excessive in the sense that no more precious metal should be used than is necessary to prevent passivation. As mentioned above, this reduces material costs considerably.

In one embodiment the first layer may comprise tantalum or an alloy of tantalum. Alternatively or additionally, it may comprise any other suitable refractory metal, such as niobium, titanium, zirconium, etc., and/or an alloy of any of these refractory metals.

As mentioned above, the body part is preferably made from a metal or an alloy, in which case the first layer preferably comprises an alloy of a refractory metal and a metal present in the body part. In this embodiment the first layer may be formed on the body part by applying the refractory metal in such a way that a desired alloying takes place. Thereby the corrosion resistance of the object is improved. Furthermore, the amount of refractory metal needed in order to ensure the desired corrosion resistant properties may be lower than is the case when a separate layer is applied on top of the body part. For example, if the body part is made from titanium or an alloy of titanium, and if the refractory metal is tantalum, a titanium/tantalum alloy may be formed at the surface of the body part. In this case the amount of tantalum needed in order to provide a layer which is sufficiently corrosion resistant will be less than the amount needed if a separate layer of tantalum was to be applied to the body part. Furthermore, in this case the metallurgical bond between the first and the second layer may be provided in such a way that, due to thermal diffusion, an alloy of the refractory metal, the metal present in the body part and the precious metal is present in the second layer. Thus, in an example where a titanium bulk part is coated with a corrosion resistant layer of tantalum, and the tantalum layer is coated with an electrically conductive platinum top layer, small concentrations of titanium and platinum may be present in the first layer (tantalum) without compromising the conductive and protective properties of the first layer. In addition, metal of the top layer may be present in the bulk material and/or metal of the bulk material may be present in the top layer.

A special situation also covered by the present invention is when diffusion has resulted in that the first and second layers have been fully alloyed, e.g. metal from the first layer is present In the upper part of the second layer. Under such conditions, the top layer will, after processing, be an alloy, but it should still be capable of protecting the surface from passivation.

The body part may have a conductivity within the interval 0.01×10⁶ Ω⁻¹cm⁻¹ to 0.65×10^{6 Ω}⁻¹cm⁻¹.

The object preferably is or forms part of an electrode. Due to the conductive and corrosion resistant properties of such an electrode, it will be very suitable for being used in a hostile and corrosive environment. Furthermore, as mentioned above, the manufacturing costs are considerably reduced relatively to prior art electrodes suitable for use in such environments.

According to a second aspect of the invention the above and other objects are fulfilled by providing a method of forming an object, the method comprising the steps of:
providing an electrically conductive body part,
applying a first layer to a surface part of the body part, said first layer comprising a refractory metal or an alloy of a refractory metal,
applying a second layer on top of the first layer, said second layer comprising a precious metal, and
heating at least the second layer during or after applying the second layer, thereby forming a metallurgical bond between the first and second layer.

As mentioned above, the step of heating at least the second layer, thereby forming a metallurgical bond between the first and second layer, makes it possible to provide a corrosion resistant and conductive object in which passivation of the object is avoided during conducting in a cost effective manner. Thus, the material costs may be considerably reduced without jeopardising the properties mentioned above.

Thus, the present invention provides a procedure which may be applied to electrodes where the precious metal layer in itself is not sufficiently tight to prevent oxidation of layers positioned beneath the precious metal layer. By applying a sufficiently high temperature to create solid phase diffusion between a passive layer and the precious metal layer, where a metallurgical bond exists, it is possible to maintain the conductivity and corrosion resistance in situations where the precious metal does not provide corrosion resistance, nor is substantially cohesive.

The heating step may be performed by heating at least the second layer to a temperature within the interval 400° C. to 1500° C. This will in most cases ensure that a metallurgical bond is formed between the first and second layer.

The step of applying the second layer may be performed using evaporation techniques. Such evaporation techniques may be, but are not limited to, physical vapour deposition (PVD) or chemical vapour deposition (CVD).

Alternatively, the step of applying the second layer may be performed by means of galvanic electrolysis. In this case the refractory metal preferably forms a cathode during the electrolysis process.

Alternatively, the step of applying the second layer may be performed in any other suitable manner, such as by spraying or painting the layer onto the first layer.

According to a third aspect of the invention the above and other objects are fulfilled by providing a method of preventing formation of an oxide layer on an electrode, the method comprising the steps of:
providing an electrode having an electrically conducting body part,
applying a first layer to a surface part of the electrode, said first layer comprising a refractory metal or an alloy of a refractory metal,
applying a second layer on top of the first layer, said second layer comprising a precious metal, and
heating at least the second layer during or after applying the second layer, thereby forming a metallurgical bond between the first and second layer, thereby preventing formation of an oxide layer on the first layer.

It should be noted that a skilled person would readily recognise that any feature described in combination with the first aspect of the invention may equally be combined with the second and third aspects of the invention, any feature described in combination with the second aspect may equally be combined with the first and third aspects of the invention, and any feature described in combination with the third aspect of the invention may equally be combined with the first and second aspects of the invention.

### BRIEF DESCRIPTION OF THE DRAWINGS

The invention will now be described with reference to the accompanying drawings in which:

FIG. 1 shows an object according to an embodiment of the invention having a body part and a layer comprising a refractory metal,

FIG. 2 shows the object of FIG. 1 additionally having a layer comprising a precious metal, and

FIG. 3 shows the object of FIGS. 1 and 2, where a metallurgical bond has been formed between the refractory metal layer and the precious metal layer.

### DETAILED DESCRIPTION OF THE DRAWINGS

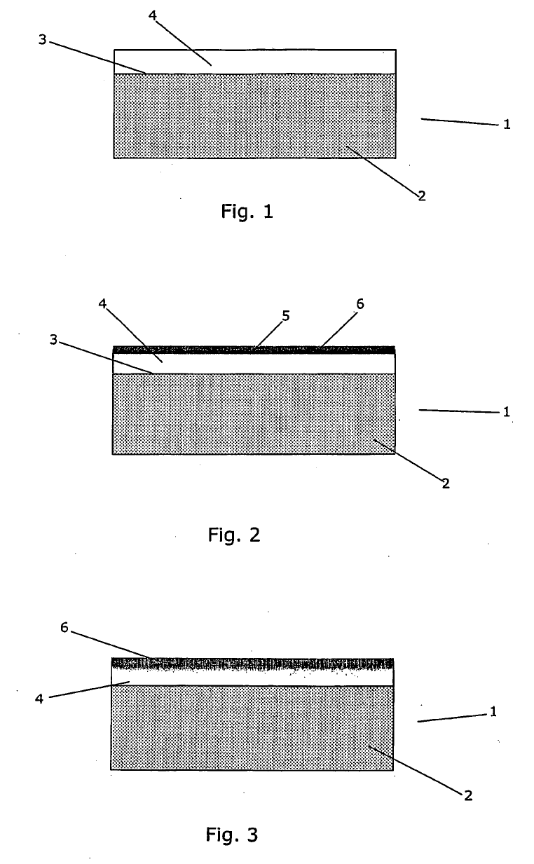

FIG. 1 shows an object 1 having an electrically conductive body part 2, e.g. being made from or comprising copper or silver. On an outer surface 3 of the body part 2 a layer 4 comprising a refractory metal, e.g. tantalum, has been applied in order to improve the corrosion resistant properties of the object 1.

FIG. 2 shows the object 1 of FIG. 1. In FIG. 2 an outer surface 5 of the refractory metal layer 4 has been provided with a layer 6 comprising a precious metal, e.g. platinum or gold, in order to prevent oxidation of the refractory metal layer 4 when a current is applied to the object 1, thereby also preventing passivation of the object 1.

FIG. 3 shows the object 1 of FIGS. 1 and 2. In FIG. 3 the object 1 has been treated in such a way that a metallurgical bond has been formed between the refractory metal layer 4 and the precious metal layer 6. This has the advantage that even with a relatively thin layer 6 of precious metal passivation is prevented. Thereby material costs may be considerably reduced without compromising the desired properties in terms of corrosion resistance and prevention of passivation.

What is claimed is:

1. An object comprising:
an electrically conductive body part,
a first layer comprising a refractory metal or an alloy of a refractory metal, said first layer at least substantially covering an outer surface of the body part, and
a second layer comprising a precious metal, said second layer at least substantially covering the first layer,
wherein a metallurgical bond has been formed between the first and the second layer.

2. The object according to claim 1, wherein the first layer has a thickness within the interval 2 μm to 200 μm.

3. The object according to claim 1, wherein the second layer has a thickness within the interval 0.01 μm to 5 μm.

4. The object according to claim 1, wherein the first layer comprises tantalum or an alloy of tantalum.

5. The object according to claim 1, wherein the body part comprises a metal or an alloy, and wherein the first layer comprises an alloy of a refractory metal and a metal present in the body part.

6. The object according to claim 1, wherein the body part has a conductivity within the interval 0.01×10⁶ Ω⁻¹cm⁻¹ to 0.65×10⁶ Ω⁻¹cm⁻¹.

7. The object according to claim 1, wherein the object is or forms part of an electrode.

8. A method of forming an object, the method comprising the steps of:
providing an electrically conductive body part,
applying a first layer to a surface part of the body part, said first layer comprising a refractory metal or an alloy of a refractory metal,
applying a second layer on top of the first layer, said second layer comprising a precious metal, and
heating at least the second layer during or after applying the second layer, thereby forming a metallurgical bond between the first and second layer.

9. The method according to claim 8, wherein the heating step is performed by heating at least the second layer to a temperature within the interval 400° C. to 1500° C.

10. The method according to claim 8, wherein the step of applying the second layer is performed using evaporation techniques.

11. The method according to claim 8, wherein the step of applying the second layer is performed by means of galvanic electrolysis.

12. The method according to claim 8, wherein the body part comprises a metal or an alloy, and wherein the step of applying the first layer is performed in such a way that the resulting first layer comprises an alloy of a refractory metal and a metal present in the body part.

13. A method of preventing formation of an oxide layer on an electrode, the method comprising the steps of:
providing an electrode having an electrically conducting body part,
applying a first layer to a surface part of the electrode, said first layer comprising a refractory metal or an alloy of a refractory metal,
applying a second layer on top of the first layer, said second layer comprising a precious metal, and
heating at least the second layer during or after applying the second layer, thereby forming a metallurgical bond between the first and second layer, thereby preventing formation of an oxide layer on the first layer.
